(19) United States
(12) Patent Application Publication
(10) Pub. No.: US 2008/0128967 A1
(43) Pub. Date: Jun. 5, 2008

(54) Spring loaded floating grommet

(75) Inventor: Alexandru Borcea, East Hartford, CT (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: United Technologies Corporation, Hartford, CT (US)

(21) Appl. No.: 11/511,024

(22) Filed: Aug. 28, 2006

(51) Int. Cl. F16F 1/00

(52) U.S. Cl. 267/150

(57) ABSTRACT

A spring loaded grommet assembly comprises a housing, a grommet, and a spring member. The housing has an outer surface and an inner surface. The grommet has an outer surface and a central aperture for receiving an elongate element. The spring member is disposed between the inner surface of the housing and the outer surface of the grommet to allow lateral movement of the grommet.

### BACKGROUND OF THE INVENTION

The present invention relates generally to fastening assemblies. More particularly, the present invention relates to a floating grommet assembly that includes one or more spring members configured to dampen movement of an elongate element passing through the grommet assembly.

In general, turbine engines include various types of “carried-on” instruments for measuring conditions within the engine. These instruments typically operate in harsh environments that include high temperatures, corrosive gases, high surrounding pressure, and changing vibration frequencies.

In their most basic form, turbine engines are formed from many concentric components, beginning with an outer engine casing. Most often, the “measurement” instruments are mounted radially from the outer engine casing and in toward the engine components. As a result, the instruments must traverse apertures in several walls to reach the target area required for measurement.

A typical problem that arises when trying to traverse concentric walls with, for example, a measurement instrument, is “stack-up.” The stack-up problem arises because the tolerances associated with the apertures in each wall make it difficult to have a perfect radial alignment between the outermost and innermost walls. In addition, the stack-up problem is amplified when vibration or other external forces act upon the components, thereby causing movement of the components relative to one another. Without a sufficient means to take these problems into account, a bending load will be exerted upon the instrument traversing through the layers of concentric components, thereby risking damage to the instrument.

These “stack-up” and vibration problems are common in areas other than in aircraft engine assemblies as well. For example, any time it is necessary to fix an elongate element between two or more separate components that may move relative to one another, the movement may result in detrimental bending loads placed upon the elongate element.

Thus, there exists a need for a fastening assembly that is capable of taking into account problems of stack-up and vibration to minimize the detrimental loads placed upon an element such as a measurement instrument.

### BRIEF SUMMARY OF THE INVENTION

The present invention is a spring loaded grommet assembly comprising a housing, a grommet, and a spring member. The housing has an outer surface and an inner surface. The grommet has an outer surface and a central aperture for receiving an elongate element. The spring member is disposed between the inner surface of the housing and the outer surface of the grommet to allow lateral movement of the grommet.

### BRIEF DESCRIPTION OF THE DRAWINGS

FIG. 1A is a diagram illustrating a cross-section of an aircraft turbine engine assembly having an engine casing and a turbine engine disposed within the engine casing.

FIG. 1B is a diagram illustrating a cross-section of the aircraft turbine engine assembly of FIG. 1A after movement of the turbine engine relative to the engine casing.

FIG. 2 is a top view of a spring loaded grommet assembly according to the present invention.

FIG. 3 is a cross-sectional view of the spring loaded grommet assembly of FIG. 2.

FIG. 4 is a top view of the spring loaded grommet assembly of FIG. 2 illustrating movement of a grommet in the x-direction and the y-direction.

FIG. 5 is cross-sectional view of an alternative embodiment of the spring loaded grommet assembly according to the present invention.

FIG. 6 is a perspective view of one embodiment of a spring washer.

FIG. 7 is a cross-sectional view of the spring loaded grommet assembly of FIG. 5 illustrating movement of a grommet in the z-direction.

FIG. 8 is a cross-sectional view of the spring loaded grommet assembly of FIG. 5 illustrating a tilting movement of the grommet.

### DETAILED DESCRIPTION

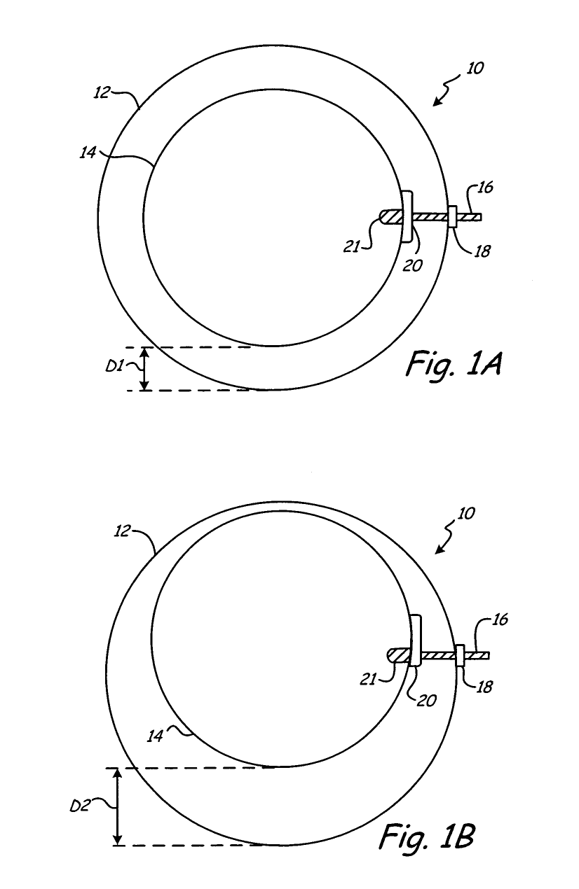

FIG. 1A is a diagram illustrating a cross-section of an aircraft turbine engine assembly 10, which includes outer case 12, inner case 14, measurement instrument 16, fixed coupling 18, and spring loaded grommet assembly 20. As shown in FIG. 1A, inner case 14 is concentric and within outer case 12.

Measurement instrument 16 is inserted through fixed coupling 18 and grommet assembly 20 and into inner case 14, as illustrated in FIG. 1A. In particular, fixed coupling 18 rigidly couples a first end of measurement instrument 16 to outer case 12 while grommet assembly 20 couples a second end of measurement instrument 16 to inner case 14 such that measurement tip 21 is disposed within the engine. Although the particular type of measurement instrument is not critical to the operation of the present invention, examples of measurement instruments include instruments that measure temperature or pressure.

As shown in FIG. 1A, inner case 14 is spaced apart from outer case 12 by a distance D1. In this position, measurement instrument 16 is supported by and centered within grommet assembly 20. As will be illustrated in the following figure, grommet assembly 20 allows inner case 14 to move relative to outer case 12 while maintaining the position of measurement instrument 16 within inner case 14.

FIG. 1B is a diagram illustrating a cross-section of aircraft turbine engine assembly 10 after movement of inner case 14 relative to outer case 12. In particular, inner case 14 has moved in an upward direction relative to outer case 12 such that inner case 14 is now spaced apart from outer case 12 by a distance D2. Although the first end of measurement instrument 16 is rigidly fixed to outer case 12, the second end of measurement instrument 16 is allowed to move within grommet assembly 20. As a result, grommet assembly 20 is able to “absorb” the relative movement between inner case 14 and outer case 12 while maintaining the position of measurement tip 21 within the engine.

The relative movement between inner case 14 and outer case 12 may result from numerous occurrences, including but not limited to vibration, loads generated by streams of wind or gas, a temperature differential, a material dependent coefficient of thermal expansion differential, a thermal inertia differential, or pressure induced displacements.

Grommet assembly 20 has been described as useful in aircraft turbine engine assemblies comprising multiple layers of casings or components that may shift relative to one another during operation. However, as will be evident from the following disclosure, the spring loaded grommet assembly of the present invention may be useful in any application that involves an elongate element coupled to two distinct surfaces that may move relative to one another. Thus, grommet assembly 20 has been described in reference to aircraft engine assemblies utilizing measurement instruments merely for purposes of example and not for limitation.

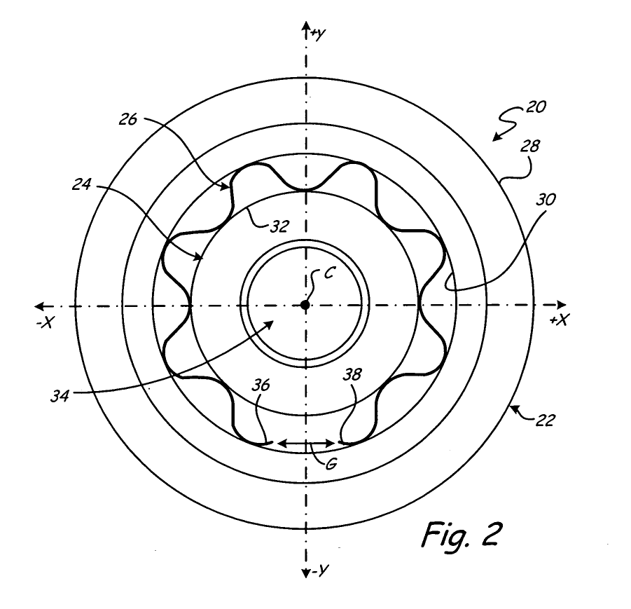

FIG. 2 is a top view of spring loaded grommet assembly 20, which includes housing 22, grommet 24, and spring member 26. Grommet assembly 20 also includes a cover member, which has been removed in order to see the interior components of the assembly. Housing 22 is cylindrical in shape and includes outer surface 28 and inner surface 30. Grommet 24 is cylindrical in shape and includes outer surface 32 and central aperture 34. It should be noted that housing 22 is illustrated as a cylinder merely for purposes of example and not for limitation. Thus, housing 22 may take on any other shape without departing from the intended scope of the present invention.

As shown in FIG. 2, spring member 26 is generally circular in shape and disposed between inner surface 30 of housing 22 and outer surface 32 of grommet 24. Spring member 26 is preferably an undulating ribbon of material having spring-like properties. Spring member 26 may be manufactured from any suitable material, such as sheet metal or wire. As illustrated in FIG. 2, spring member 26 includes a gap G between first end 36 and second end 38. Gap G allows the undulations in spring member 26 to extend while deforming elastically in response to movement of grommet 24 within housing 22. However, embodiments of the present invention that include spring members that are continuous and do not include gap G are also contemplated.

Spring member 26 is preferably positioned between housing 22 and grommet 24 in such a way that it is not attached to either component and may freely move between them. Allowing spring member 26 to freely move generates the effectiveness of the grommet assembly in absorbing or damping motion of grommet 24 within housing 22.

As illustrated in FIG. 2, a center point C of aperture 34 is aligned with the origin of the x-y axis drawn on top of grommet assembly 20. This illustrates another benefit of grommet assembly 20, which is to center grommet 24 inside of housing 22. Even when grommet 24 is forced to move in the x-direction or the y-direction due to, for example, relative movement between inner case 14 and outer case 12 as described above in reference to FIG. 1B, spring member 26 will “re-center” grommet 24 within housing 22 upon reversal of the relative movement.

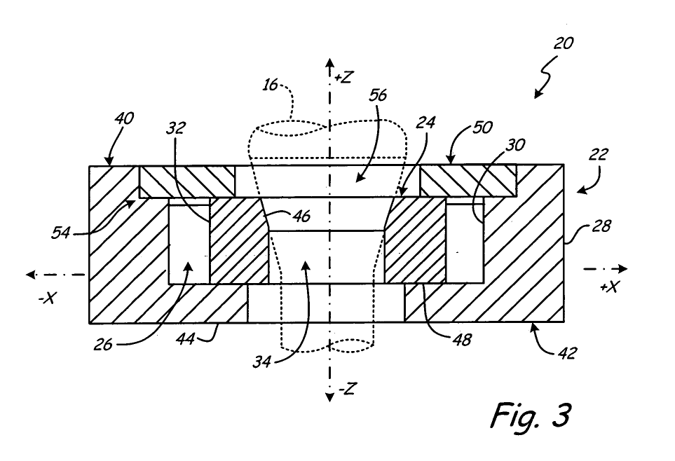

FIG. 3 is a cross-sectional view of grommet assembly 20. As illustrated in FIG. 3, housing 22 further includes top side 40, bottom side 42, and bottom flange 44, while central aperture 34 of grommet 24 includes a conical surface 46. In FIG. 3, measurement instrument 16 is shown in phantom lines positioned within grommet assembly 20. As illustrated in FIG. 3, housing 22 of grommet assembly 20 includes a large aperture on top side 40 and a smaller aperture on bottom side 42. Measurement instrument 16 is generally inserted through the larger aperture in top side 40, grommet-24, and finally, through the smaller aperture in bottom side 42 of housing 22.

When positioned within housing 22, a bottom side 48 of grommet 24 rests on and is supported by a circular bottom flange 44 of housing 22. Similarly, spring member 26 also rests on and is supported by bottom flange 44 of housing 22. As shown in FIG. 3, conical surface 46 of grommet 24 is configured to mate with a conical surface of measurement instrument 16. Conical surface 46 allows the conical end of measurement instrument 16 to be loaded against grommet 24 in the negative z-direction.

As shown in FIG. 3, cover member 50 (which was removed in FIG. 2) has been attached to top side 40 of housing 22. Cover member 50 is a circular disk configured to mate with shoulder 54 near top side 40 of housing 22 to retain grommet 24 and spring member 26 within housing 22. Cover member 50 includes cover bore 56 sized so as to allow measurement instrument 16 to protrude through top side 40 of housing 22 with sufficient space to move in the x-direction, the y-direction, and the z-direction.

As illustrated in FIG. 3, the top side of cover member 50 is flush with top side 40 of housing 22. However, cover members that are not flush with top side 40 of housing 22, as well as cover members that mate with surfaces other than shoulder 54, are within the intended scope of the present invention. Furthermore, cover member 50 may be coupled to housing 22 in various ways including, but not limited to, press-fitted, threaded, welded, brazed, stacked, or swaged.

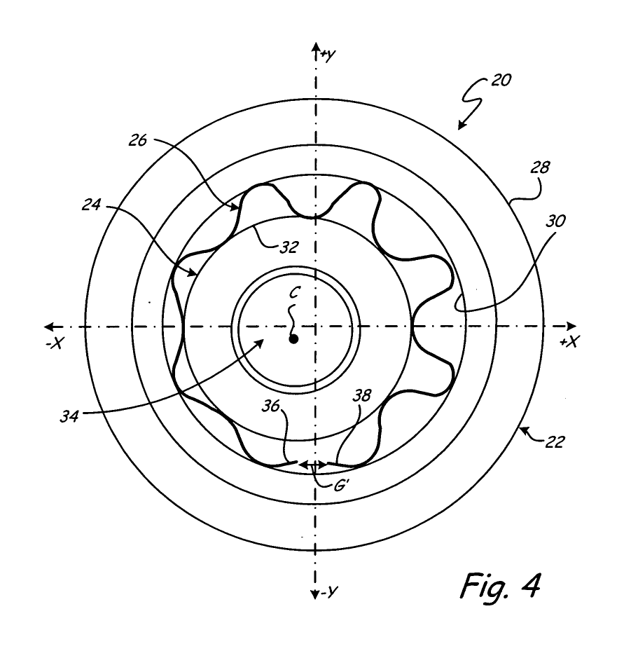

FIG. 4 is a top view of grommet assembly 20 (with cover member 50 removed) illustrating lateral movement of grommet 24 in the x-direction and the y-direction within housing 22. In particular, as illustrated in FIG. 4, center point C of aperture 34 is no longer aligned with the x-y origin of grommet assembly 20. Instead, center point C of aperture 34 is now positioned in the lower left quadrant of the x-y plot, which means grommet 24 has moved laterally in the negative x-direction and the negative y-direction.

As shown in FIG. 4, lateral movement of grommet 24 in any direction in the x-y plane causes spring member 26 to deform (i.e., the circumferential “undulations” are no longer uniform in shape). As a result of the deformation of spring member 26, a gap G′ now exists between first end 36 and second end 38 which is different than gap G illustrated in FIG. 2 where grommet 24 is centered within housing 22. Because of its spring-like properties, spring member 26 has the inherent tendency to return to its non-deformed shape and re-center grommet 24 within housing 22 to dampen the vibration or other source of movement of grommet 24.

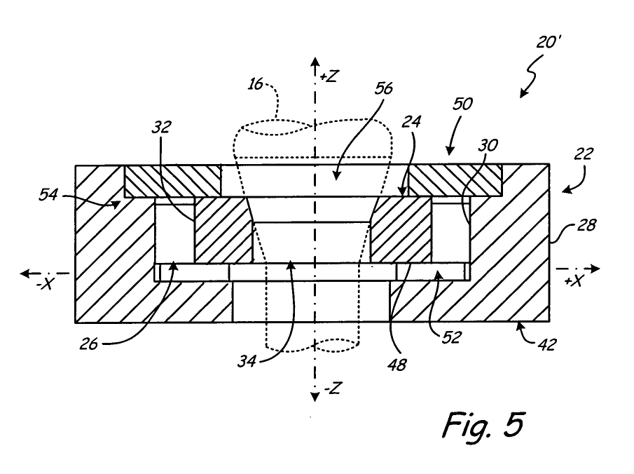

FIG. 5 is an alternative embodiment of spring loaded grommet assembly 20′, which is similar to spring loaded grommet assembly 20 of FIGS. 1-4 but further includes spring washer 52. Spring washer 52 is a circular, undulating disk member disposed between bottom side 48 of grommet 24 and bottom side 42 of housing 22. As will be illustrated in the following figures, spring washer 52 is configured to allow movement of grommet 24 in the z-direction within housing 22. Therefore, in embodiments of the present invention that include both spring member 26 and spring washer 52, such as spring loaded grommet assembly 20′, grommet 24 (and therefore, measurement element 16) is capable of movement in the x-direction, the y-direction, and the z-direction. Furthermore, since grommet 24 is “floating” within housing 22 (i.e., not rigidly attached to any other component), grommet 24 is also capable of rotating within housing 22 in addition to movement in the x, y, and z-directions.

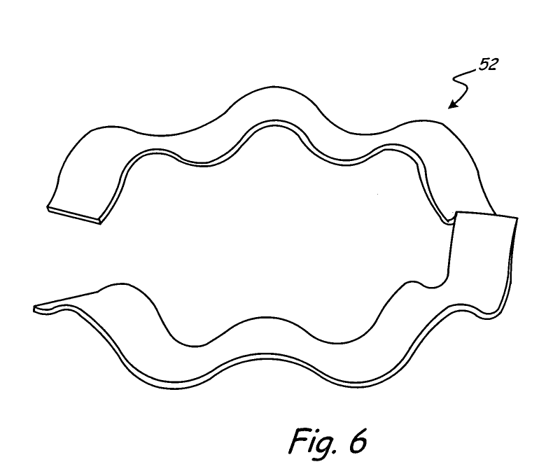

FIG. 6 is a perspective view of one embodiment of spring washer 52. As shown in FIG. 6, spring washer 52 is an undulating ribbon having a generally circular shape. Similar to spring member 26 described above, the undulations present in spring washer 52, combined with the flexibility inherent in the spring washer material, allow spring washer 52 to deform when a force is applied to it. As a result, grommet 26 of spring loaded grommet assembly 20′ has the freedom to move in the z-direction as well as to tilt within housing 22.

Spring washer 52 is preferably formed from a metal such as sheet metal, although other non-metal materials that may be formed into an undulating ribbon having spring-like properties are also within the intended scope of the present invention. In addition, although spring member 52 is shown as a “broken” circular disk in FIG. 6, spring members that do not include the broken portion (i.e., are continuous) are also contemplated.

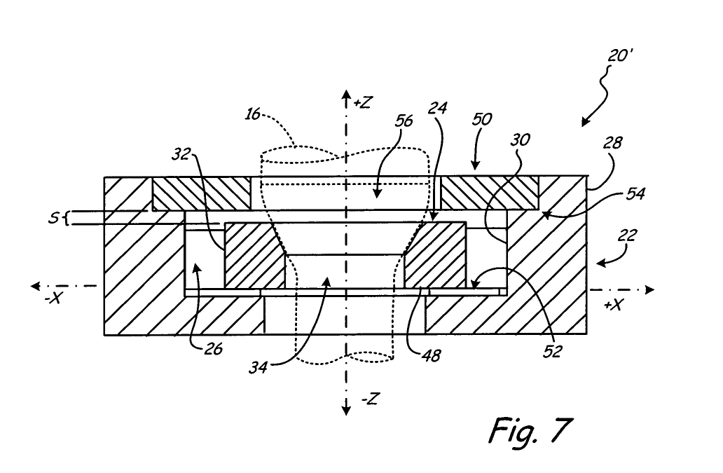

FIG. 7 is a cross-sectional view of spring loaded grommet assembly 20′ illustrating axial movement of grommet 24 in the z-direction within housing 22. In particular, grommet 24 has moved axially in the negative z-direction as illustrated by space S between the bottom side of cover member 50 and the top side of grommet 24. This space S created within housing 22 results from the deformation of spring washer 52. Because of its spring-like properties, spring washer 52 will once again push grommet 24 back in the positive z-direction when the force causing grommet 24 to move in the negative z-direction is overcome by the spring force of spring washer 52.

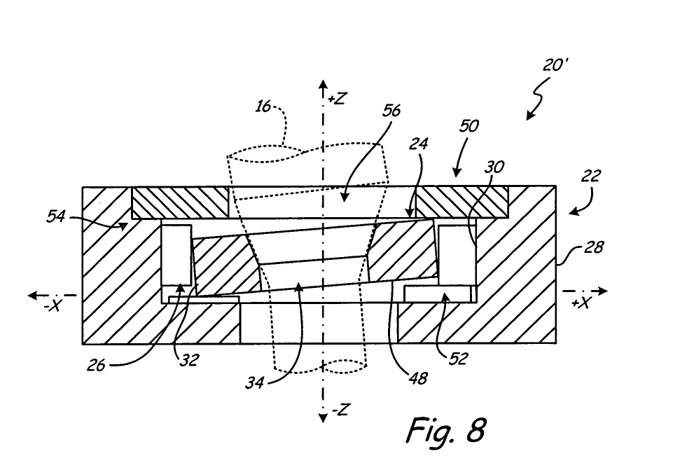

FIG. 8 is a cross-sectional view of spring loaded grommet assembly 20′ illustrating the ability of grommet 24 to “tilt” (i.e., move both laterally and axially) within housing 22. Although FIG. 8 depicts movement in only the x-direction and the z-direction, grommet 24 may also move in the y-direction when it is forced to tilt within housing 22. Thus, when grommet assembly 20′ is used to dampen movement of an elongate element (such as measurement instrument 16) or to compensate for relative movement between two surfaces to which the elongate element is attached (such as outer case 12 and inner case 14), grommet 24 may move in any combination of the three perpendicular directions as well as rotate within housing 22. Furthermore, the spring forces resulting from compression of both spring member 26 and spring washer 52 will eventually cause an automatic re-centering of grommet 24 within housing 22 once the spring forces are able to overcome the forces that caused the movement of grommet 24.

It should be understood that various other embodiments consistent with the details described above are possible and within the intended scope of the present invention. Thus, the embodiments illustrated above are shown merely for purposes of example and not for limitation. In addition, although spring member 26 and spring washer 52 have been described as “undulating ribbons” having a generally circular shape, these elements may be replaced by numerous other spring-type elements having various other shapes and being formed from various other materials without departing from the intended scope of the present invention.

In some applications utilizing a spring loaded grommet assembly according to the present invention, there may be a significant amount of movement between, for example, housing 22, grommet 24, spring member 26, and spring washer 52. This movement may generate friction wear on the various components. If friction wear is a concern in a particular application, it may be reduced in numerous ways including, but not limited to, manufacturing the components from antifriction materials (e.g., phosphorous bronze or cobalt alloys), placing an antifriction coating on the surfaces of the components, or bonding antifriction material liners to the components.

Although the present invention has been described with reference to preferred embodiments, workers skilled in the art will recognize that changes may be made in form and detail without departing from the spirit and scope of the invention.

1. A spring loaded grommet assembly comprising:
a housing having an outer surface and an inner surface;
a grommet having an outer surface and a central aperture for receiving an elongate element; and
a spring member disposed between the inner surface of the housing and the outer surface of the grommet to allow lateral movement of the grommet.

2. The spring loaded grommet assembly of claim 1, wherein the spring member is configured to center the grommet within the housing.

3. The spring loaded grommet assembly of claim 1, and further comprising a cover member for retaining the grommet and the spring member within the housing.

4. The spring loaded grommet assembly of claim 3, wherein the cover member is press-fit to the housing.

5. The spring loaded grommet assembly of claim 1, and further comprising a spring washer configured to allow axial movement of the grommet.

6. The spring loaded grommet assembly of claim 5, wherein the spring washer is an undulating ribbon having a generally circular shape.

7. The spring loaded grommet assembly of claim 1, wherein the spring member is an undulating ribbon having a generally circular shape.

8. The spring loaded grommet assembly of claim 1, wherein the central aperture of the grommet comprises an angled surface configured to mate with an angled surface of the elongate element.

9. The spring loaded grommet assembly of claim 1, wherein the spring member is configured to dampen vibration of the elongate element.

10. A spring loaded grommet assembly comprising:
a housing having an outer surface and an inner surface, the inner surface defining an inner diameter of the housing;
a grommet having an outer surface defining an outer diameter and a central aperture for receiving an instrument, the outer diameter of the grommet being less than the inner diameter of the housing to allow the grommet to reside within the housing; and
spring means disposed within the housing to allow movement of the grommet within the housing.

11. The spring loaded grommet assembly of claim 10, wherein the spring means allows movement of the grommet in an x-direction and a y-direction.

12. The spring loaded grommet assembly of claim 11, wherein the spring means comprises an undulating spring disposed between the inner diameter of the housing and the outer diameter of the grommet to allow movement of the grommet in the x-direction and the y-direction.

13. The spring loaded grommet assembly of claim 11, wherein the spring means allows movement of the grommet in a z-direction.

14. The spring loaded grommet assembly of claim 13, wherein the spring means comprises a spring washer configured to allow movement of the instrument in the z-direction.

15. The spring loaded grommet assembly of claim 10, and further comprising a cover member securable to a top side of the housing to retain the grommet and the spring means within the housing.

16. The spring loaded grommet assembly of claim 10, wherein the spring means is configured to dampen vibration of the instrument.

17. A damper assembly for attaching an elongate element to a surface comprising:
a housing having an outer surface and an inner surface;
a cylindrical grommet having an outer surface and an aperture for receiving the elongate element;
a first spring member disposed between the inner surface of the housing and the outer surface of the grommet to allow lateral movement of the grommet; and
a second spring member configured to allow axial movement of the grommet.

18. The damper assembly of claim 17, and further comprising a cover member for retaining the grommet, the first spring member, and the second spring member within the housing.

19. The damper assembly of claim 17, wherein the first spring member and the second spring member are configured to dampen vibrations passing through the elongate element.

20. The damper assembly of claim 17, wherein the first and second spring members allow movement of the elongate element both laterally and axially.
